(19) United States
(12) Patent Application Publication
(10) Pub. No.: US 2019/0045788 A1
(43) Pub. Date: Feb. 14, 2019

(54) WATER DISPERSIBLE GRANULE COMPOSITION

(71) Applicant: Valent U.S.A., Corporation, Walnut Creek, CA (US)

(72) Inventors: Ke Zhou, Greenville, MS (US); Jing Liang, Greenville, MS (US)

(21) Appl. No.: 16/163,746

(22) Filed: Oct. 18, 2018

(51) Int. Cl. A01N 43/84; A01N 25/14

(52) U.S. Cl. CPC A01N 43/84; A01N 25/30; A01N 2300/00; A01N 25/14

(57) ABSTRACT

The present invention is directed to water dispersible granule compositions containing flumioxazin, pyroxasulfone and chlorimuron. The present invention is further directed to a method of controlling weeds comprising applying a composition of the present invention to the weeds or an area in need of weed control.

### FIELD OF THE INVENTION

The present invention relates to water dispersible granule compositions containing flumioxazin, pyroxasulfone and chlorimuron ethyl. The present invention further relates to a method of controlling weeds comprising applying a composition of the present invention to the weeds or an area in need of weed control.

### BACKGROUND OF THE INVENTION

Unwanted plants, such as weeds, reduce the amount of resources available to crop plants and can have a negative effect on crop plant yield and quality. For example, a weed infestation reportedly was responsible for an 80% reduction in soybean yields. Bruce, J. A., and J. J. Kells, Horseweed (Conyza Canadensis) control in no-tillage soybeans (Glycine max) with preplant and preemergence herbicides, Weed Technol. 4:642-647 (1990). Therefore, controlling weeds is a major concern of crop growers. Unwanted plants in crop plant environments include broadleaves, grasses and sedges.

Flumioxazin is a protoporphyrinogen oxidase (“PPO”) inhibitor herbicide, which is a different mode of action from glyphosate, used to control weeds among soybeans, peanuts, orchard fruits and many other agricultural crops in the United States and worldwide. Flumioxazin is effective in controlling glyphosate resistant and tough-to-control weeds.

Pyroxasulfone is relatively new isooxazoline herbicide that inhibits synthesis of very-long-chain fatty acids. Pyroxasulfone is used to control weeds among many agricultural crops including corn and soybean. However, resistance to pyroxasulfone is beginning to occur including in annual ryegrass. Busi R, et al., Inheritance of evolved resistance to a novel herbicide (pyroxasulfone), bioRxiv, Plant Sci. 217-218:127-134 (2014).

Chlorimuron ethyl is a sulfonylurea herbicide. Sulfonylurea herbicides function by interfering with the biosynthesis of amino acids including valine, isoleucine and leucine. Chlorimuron ethyl is used to control weeds among agricultural crops including grains. Chlorimuron ethyl is used extensively in South America in no-till farming techniques. However, resistance to chlorimuron ethyl is beginning to occur including white horseweed. Santos G, et al., Multiple resistance of Conyza sumatrensis to Chlorimuron-ethyl and to Glyphosate, Planta daninha, 32(2):409-416 (2014).

One way to control resistant weeds is to apply compositions containing multiple herbicides. Accordingly, there is a need in the art for a high weed control composition. Further, as no-till farming continues to increase in popularity, there is a greater need for effective herbicides. A composition with effective weed control and lower dosage rate will lead to increased crop plant yields, and decreased environmental and health concerns.

### SUMMARY OF THE INVENTION

The present invention is directed to a water dispersible granule composition comprising flumioxazin, pyroxasulfone and chlorimuron ethyl.

The present invention is further directed to a water dispersible granule composition comprising flumioxazin, pyroxasulfone, chlorimuron ethyl, ammonium sulfate, sodium lauryl sulfate, a spray dried blend of liquid nonionic surfactant and kraft sodium lignosulfonate, sodium salt of naphthalene sulfonate condensate with block copolymer, calcium phosphate, powder defoamer and hydrous aluminum silicate.

The present invention is further directed to a method of controlling weeds comprising applying a composition of the invention to a weed or an area in need of weed control.

### DETAILED DESCRIPTION OF THE INVENTION

In one embodiment, the present invention is directed to agricultural compositions comprising flumioxazin, pyroxasulfone and chlorimuron ethyl.

In one embodiment, the present invention is directed to a water dispersible granule composition comprising flumioxazin, pyroxasulfone and chlorimuron ethyl, one or more dispersants, one or more wetting agents, one or more anticaking agents, one or more inert fillers, and optionally, one or more solid defoamers.

Dispersant(s) to help disperse the active ingredient in water. Examples of suitable dispersants include, but are not limited to, sodium and ammonium salts of napthalene sulfonate-formaldehyde condensates; sodium, calcium and ammonium salts of ligninsulfonates (optionally polyethoxylated); sodium and ammonium salts of maleic anhydride copolymers, sodium salts of condensed phenolsulfonic acid, and combinations thereof.

Wetting agents improve the speed of wetting upon mixing with water. Examples of suitable anionic wetting agents include, but are not limited to, sodium salts of alkyl napthalene sulfonates, alkyl benzene sulfonates, alkyl sulfosuccinates, taurates, alkyl sulfates and phosphate esters. Examples of suitable nonionic wetting agents include acetylenic diols, alkyl phenol ethoxylates, and combinations thereof.

Anticaking agents prevent clumping of granules when stored under hot warehouse conditions. Examples include, but are not limited to, sodium and ammonium phosphates, sodium carbonate and bicarbonate, sodium acetate, sodium metasilicate, magnesium, zinc and calcium sulfates, calcium phosphates, magnesium hydroxide, (all optionally as hydrates), anhydrous calcium chloride, molecular sieves, sodium alkylsulfosuccinates, calcium and barium oxides, and combinations thereof.

Inert fillers, include but not limited to, inorganic fillers well known in the art. Non-limiting examples are swelling and non-swelling clays, synthetic and diatomaceous silicas, calcium and magnesium silicates, titanium dioxide, aluminum, calcium and zinc oxide, calcium and magnesium carbonate, ammonium, sodium, potassium, calcium and barium sulfate, charcoal, and combinations thereof.

In another embodiment, the present invention is directed to a water dispersible granule composition comprising flumioxazin, pyroxasulfone and chlorimuron ethyl, at least one dispersant selected from the group consisting of sodium lauryl sulfate, a spray dried blend of liquid nonionic surfactant and kraft sodium lignosulfonate, sodium salt of naphthalene sulfonate condensate with block copolymer.

In another preferred embodiment, the present invention is further directed to a water dispersible granule composition comprising flumioxazin, preferably from about 15% to 35% w/w, more preferably from 20% to about 30%, and most preferably 25.10%; pyroxasulfone, preferably from about 20% to 41% w/w, more preferably from 25% to about 36%, and most preferably about 31.44% w/w; chlorimuron ethyl, preferably from about 0.5% to 20% w/w, more preferably from 2% to about 15%, and most preferably about 6.84% w/w.

Sodium lauryl sulfate may be present in compositions of the present invention as a wetting agent at a concentration from about 0.5% to 10% w/w, more preferably from 1% to about 5%, and most preferably about 2.0% w/w.

A spray dried blend of liquid nonionic surfactant and kraft sodium lignosulfonate may be present in compositions of the present invention as a dispersant at a concentration from about 0.5% to 15% w/w, more preferably from 1% to about 10%, and most preferably about 5.0% w/w.

Sodium salt of naphthalene sulfonate condensate with block copolymer may be present in compositions of the present invention as a dispersant at a concentration from about 0.5% to 15% w/w, more preferably from 1% to about 10%, and most preferably about 5.0% w/w.

Compositions of the present invention may further comprise, one or more excipients selected from the group consisting one or more additional diluent, and an additional powder defoamer.

Additional additives suitable for use in the present invention include, but are not limited to, an ammonium sulfate, a calcium phosphate, a hydrous aluminum silicate, and the mixture of thereof.

An ammonium sulfate may be present in compositions of the present invention as an inert filler at a concentration from about 1% to 40% w/w, more preferably from 5% to about 30% w/w, and most preferably about 16.9% w/w.

A calcium phosphate may be present in compositions of the present invention as an anticaking agent at a concentration from about 0.5% to 10% w/w, more preferably from 1% to about 5%, and most preferably about 2.0% w/w. A preferred calcium phosphate is a monocalcium phosphate monohydrate.

A hydrous aluminum silicate may be present in compositions of the present invention as an inert filler at a concentration from about 1% to 30% w/w, more preferably from 2% to about 20%, and most preferably about 5.6% w/w.

An additional solid defoamer may be present in compositions of the present invention at a concentration from about 0.01% to 5% w/w, more preferably from 0.02% to about 2%, and most preferably about 0.1% w/w.

A 90.0 to 99.9% technical powder was used as the source of flumioxazin.

A 90.0 to 99.9% technical powder was used as the source of pyroxasulfone.

A 90.0 to 99.9% technical powder was used as the source of chlorimuron ethyl.

Stepwet® DF-95 was used as the source of sodium lauryl sulfate (Stepwet is a registered trademark and available from Stepan Company Corp.).

Stepsperse® DF-600 was used as the source of a spray dried blend of liquid nonionic surfactant and kraft sodium lignosulfonate (Stepsperse is a registered trademark of and available from Stepan Company Corp.).

Morwet® D-500 was used as the source of sodium salt of naphthalene sulfonate condensate with block copolymer (Morwet is a registered trademark of and available from Akzo Nobel Surface Chemistry LLC).

Agnique® Soap L was used as the source of powder defoamer (Agnique is a registered trademark of and available from Cognis Corporation).

ASP 200 or ASP 400P clay was used as the source of hydrous aluminum silicate (ASP is a registered trademark of and available from BASF company).

In another embodiment, the present invention is directed to a method of controlling weeds comprising applying a composition of the invention to a weed or an area in need of weed control.

Throughout the application, the singular forms “a,” “an,” and “the” include plural reference unless the context clearly dictates otherwise.

As used herein, all numerical values relating to amounts, weight percentages and the like are defined as “about” or “approximately” each particular value, plus or minus 10%. For example, the phrase “about 5.0% w/w” is to be understood as “from 4.5% to 5.5% w/w.” Therefore, amounts within 10% of the claimed values are encompassed by the scope of the claims.

These representative embodiments are in no way limiting and are described solely to illustrate some aspects of the invention.

Further, the following examples are offered by way of illustration only and not by way of limitation.

### EXAMPLES

### Example 1—A Water Dispersible Granule Composition

TABLE 1
Water dispersible granule composition

| Ingredient | Concentration (w/w) |
|---|---|
| Flumioxazin (97.9%) | 25.1% |
| Pyroxasulfone (99.13%) | 31.44% |
| Chlorimuron Ethyl (97.5%) | 6.84% |
| Ammonium sulfate | 16.9% |
| Stepwet ® DF-95 | 2.0% |
| Stepsperse ® DF-600 | 5.0% |
| Morwet ® D-500 | 5.0% |
| Calcium phosphate | 2.0% |
| Agnique ® soap L | 0.1% |
| ASP ® 200 clay | 5.6% |

### Example 2—Process for Preparation of the Water Dispersible Granule Composition

Blend ammonium sulfate, monocalcium phosphate monohydrate, Stepwet® DF-95, Stepsperse® DF-600, Morwet® D-500, ASP® 200 or ASP® 400P, Agnique® soap L, flumioxazin technical, pyroxasulfone technical, and chlorimuron ethyl technical at the ratio from Table 1, above. Pass the blended product through a hammermill to remove lumps and reduce the particle size and then followed by passing the product through an air mill to reduce the particle size to the desired size. Feed the dry powder into a continuous kneader. Add approximately 15 wt % water to the powder to form a dough. Feed the dough through a extruder fitted with 0.8 or 1.0 mm screens to produce granules. Transfer the granules to a fluid bed dryer operating at 50° C. Dry the granules to a moisture content below 1.5%. Water dispersible granule prepared was subjected to different temperature conditions, specifically, 5 free/thaw cycles (−10° C. to 40° C.), 2 weeks at 54° C., 4 weeks at 50° C., 8 weeks at 50° C. and 40° C., 16 weeks at 40° C., and 6 month at room temperature to determine long-term storage stability. Sprayability, dispersibility, redispersibility, and suspensibility were measured prior to and at the conclusion of each of the extreme temperature conditions.

Method

### Sprayability

Sprayability is based on the following test procedure and calculation. A 100-mesh (150 micrometer) sieve is weighed and the weight is recorded as the tare weight (“W0”). The sieve is then placed over a wide mouth jar.

50 grams of a composition (“W”) is weighed and added to 600 milliliters of tap water, the composition was then stirred for approximately two minutes to create a dispersion.

The entire dispersion was poured through the sieve followed by rinsing. Rinsing was done using tap water at a flow rate at about 1.5 liters per minute for one minute. The sieve with the residue was then placed in a drying oven and dried to create the dry sieve with the residue (“W1”). Percent sprayability was then calculated with the following equation: (W1−W0)/W*100.

A large percent sprayability indicates poor formulation stability leading to nozzle clogging during field application. Formulation should have a sprayability no more than 0.05% w/w under all conditions.

### Suspensibility

Suspensibility is based on the following test procedure and calculation. One gram of a composition (“W”) was added to 50 milliliters of 324 ppm hard water in a beaker, the composition was then stirred for approximately two minutes to create a dispersion.

The entire dispersion was transferred into a 100-milliliter graduated cylinder. The cylinder was then filled to the 100-milliliter mark using 324 parts per million hard water. The cylinder was run through 30 cycles of inversion and reversion with one complete cycle every two seconds. The graduated cylinder was then left undisturbed for 30 minutes. Following rest, the top 90 milliliters were removed from the cylinder using a vacuum apparatus. The remaining 10 milliliters of material was then transferred into a tared evaporation dish (“W0”). The dish with the material was placed in a drying oven and dried to a constant weight (“W1”). Percent suspensibility was calculated using the following equation: ((W*A/100)−(W1−W0))*111/(W*A/100), wherein A=percentage of solid content in the sample (determined from the formulation of the composition).

A low percent suspensibility indicates poor formulation stability leading to precipitation of the composition.

### Dispersibility

Dispersibility was measured by adding one milliliter of a composition to a 100 milliliter graduated cylinder containing 99 milliliters of 324 parts per million hard water. The cylinder was then run through cycles of inversion and reversion with one complete cycle every 2 seconds. Dispersiblity is the number of cycles it takes to disperse the formulation uniformly. A high dispersibility value indicates poor formulation stability.

### Redispersibility

After the dispersibility test is done, the dispersed formulation was undisturbed for 24 hours. The cylinder was then run through cycles of inversion and reversion with one complete cycle every two seconds. Redispersiblity is the number of cycles it takes to disperse the formulation uniformly after sitting. A high redispersibility value indicates poor formulation stability.

TABLE 2
Stability Results

| | | Storage Condition (Initial) | | | | | | | |
|---|---|---|---|---|---|---|---|---|---|
| | | | | 54 C./ | | | | | |
| | | Initial | F/T | 2 wk | 50 C./4 wk | 50 C./8 wk | 40 C./8 wk | 40 C./16 wk | R.T./6 M |
| Sprayability (tap water, | | 0.000% | 0.000% | 0.000% | 0.000% | 0.014% | 0.000% | 0.000% | 0.000% |
| 100 mesh sieve) | | | | | | | | | |
| Dispersibility | 342 ppm water | 16 | 18 | 19 | 15 | 15 | 20 | 17 | 17 |
| Sediment | 342 ppm water | ⅙ | 2/6 | ¼ | ⅓ | ¼ | ¼ | ⅖ | ⅖ |
| Suspensibility | 342 PPM water | 98.34 | 96.44 | 87.97 | 81.00 | 84.15 | 86.90 | 91.98 | 91.98 |
| (1 g/100 ml) | (%) | | | | | | | | |

What is claimed is:

1. A water dispersible granule composition comprising flumioxazin, pyroxasulfone and chlorimuron ethyl.

2. The composition of claim 1, further comprising one or more dispersants and one or more wetting agents.

3. The composition of claim 2, wherein:
the one or more dispersants is selected from the group consisting of sodium and ammonium salts of napthalene sulfonate-formaldehyde condensates; sodium, calcium and ammonium salts of ligninsulfonates (optionally polyethoxylated); sodium and ammonium salts of maleic anhydride copolymers, sodium salts of condensed phenolsulfonic acid, and a combination of thereof; and
the one or more wetting agents is selected from the group consisting of sodium salts of alkyl napthalene sulfonates, alkyl benzene sulfonates, alkyl sulfosuccinates, taurates, alkyl sulfates and phosphate esters. Examples of suitable nonionic wetting agents include acetylenic diols, alkyl phenol ethoxylates and a combination of thereof.

4. The composition of claim 2, further comprising one or more anticaking agents, one or more inert fillers, and optionally, one or more solid defoamer.

5. The composition of claim 4, wherein:
the one or more dispersants is selected from the group consisting of sodium and ammonium salts of napthalene sulfonate-formaldehyde condensates; sodium, calcium and ammonium salts of ligninsulfonates (optionally polyethoxylated); sodium and ammonium salts of maleic anhydride copolymers, sodium salts of condensed phenolsulfonic acid, and a combination of thereof;
the wetting agent is selected from sodium salts of alkyl napthalene sulfonates, alkyl benzene sulfonates, alkyl sulfosuccinates, taurates, alkyl sulfates and phosphate esters. Examples of suitable nonionic wetting agents include acetylenic diols, alkyl phenol ethoxylates and a combination thereof;
the one or more anticaking agents is selected from the group consisting of sodium and ammonium phosphates, sodium carbonate and bicarbonate, sodium acetate, sodium metasilicate, magnesium, zinc and calcium sulfates, calcium phosphates, magnesium hydroxide, (all optionally as hydrates), anhydrous calcium chloride, molecular sieves, sodium alkylsulfosuccinates, calcium and barium oxides, and a combination thereof; and
the one or more inert fillers is selected from the group consisting of swelling and non-swelling clays, synthetic and diatomaceous silicas, calcium and magnesium silicates, titanium dioxide, aluminum, calcium and zinc oxide, calcium and magnesium carbonate, ammonium, sodium, potassium, calcium and barium sulfate, charcoal, and a combination thereof.

6. A method of controlling weeds comprising applying a composition of claim 1 to a weed or an area in need of weed control.

7. A method of controlling weeds comprising applying a composition of claim 2 to a weed or an area in need of weed control.

8. A method of controlling weeds comprising applying a composition of claim 3 to a weed or an area in need of weed control.

9. A method of controlling weeds comprising applying a composition of claim 4 to a weed or an area in need of weed control.

10. A method of controlling weeds comprising applying a composition of claim 5 to a weed or an area in need of weed control.

11. A water dispersible granule composition comprising flumioxazin, pyroxasulfone, chlorimuron ethyl, ammonium sulfate, sodium lauryl sulfate, a spray dried blend of liquid nonionic surfactant and kraft sodium lignosulfonate, sodium salt of naphthalene sulfonate condensate with block copolymer, calcium phosphate, powder defoamer and hydrous aluminum silicate.

12. A method of controlling weeds comprising applying a composition of claim 11 to a weed or an area in need of weed control.

13. A water dispersible granule composition comprising:
from about 15% to 35% w/w flumioxazin;
from 20% to about 41% w/w pyroxasulfone;
from 0.5% to about 20% w/w chlorimuron ethyl;
from about 0.5% to 10% w/w Sodium lauryl sulfate;
from about 0.5% to 15% w/w a spray dried blend of liquid nonionic surfactant and kraft sodium lignosulfonate; and
from about 0.5% to 15% w/w sodium salt of naphthalene sulfonate condensate with block copolymer,
wherein w/w denotes weight by total weight of the composition.

14. The composition of claim 13 further comprising:
from about 1% to 40% w/w ammonium sulfate;
from about 0.5% to 10% w/w calcium phosphate;
from about 1% to 30% w/w hydrous aluminum silicate; and
optionally, from about 0.01% to 5% w/w solid defoamer

15. The composition of claim 14, comprising about 25.1% w/w flumioxazin, about 31.44% w/w pyroxasulfone, about 6.84% w/w chlorimuron, about 16.9% w/w ammonium sulfate, about 2.0% w/w sodium lauryl sulfate, about 5.0% w/w of a spray dried blend of liquid nonionic surfactant and kraft sodium lignosulfonate, about 5.0% w/w of a sodium salt of naphthalene sulfonate condensate with block copolymer, about 2.0% w/w calcium phosphate, about 0.1% w/w powder defoamer and 5.6% w/w hydrous aluminum silicate.

16. A method of controlling weeds comprising applying a composition of claim 13 to a weed or an area in need of weed control.

17. A method of controlling weeds comprising applying a composition of claim 14 to a weed or an area in need of weed control.

18. A method of controlling weeds comprising applying a composition of claim 15 to a weed or an area in need of weed control.
